(19) United States
(12) Patent Application Publication
(10) Pub. No.: US 2025/0329966 A1
(43) Pub. Date: Oct. 23, 2025

(54) Grounding Connection Member and Connector

(71) Applicant: Tyco Electronics (Shanghai) Co., Ltd., Shanghai (CN)

(72) Inventors: Hua He, Shanghai (CN); Yong (Chris) Wang, Shanghai (CN); Yingchun (David) Wang, Shanghai (CN); Yong Yang, Shanghai (CN); Daokuan (Jeremy) Zhang, Shanghai (CN)

(73) Assignee: Tyco Electronics (Shanghai) Co., Ltd., Shanghai (CN)

(21) Appl. No.: 19/180,619

(22) Filed: Apr. 16, 2025

(30) Foreign Application Priority Data
Apr. 17, 2024 (CN) 202410466723.4

(51) Int. Cl. H01R 13/6597

(52) U.S. Cl. CPC H01R 13/6597

(57) ABSTRACT

A grounding connection member includes a cylindrical body, an elastic arm, a pair of side wings, and a pair of elastic sheets. The cylindrical body has a C-shaped cross-section, a front end, and a rear end opposite each other in an axial direction of the cylindrical body, and an opening extending between the front end and the rear end. The elastic arm is connected to the front end and electrically contacts a grounding terminal of a connector. The pair of side wings each connect to one side of the opening and spread in opposite directions. The pair of elastic sheets are each formed on one side wing and electrically contact an outer shielding shell of the connector.

### CROSS-REFERENCE TO RELATED APPLICATION

This application claims the benefit of the filing date under 35 U.S.C. § 119(a)-(d) of Chinese Patent Application No. CN202410466723.4 filed on Apr. 17, 2024.

### FIELD OF THE INVENTION

The present invention relates to a connection member and, more particularly, to a grounding connection member and a connector comprising the grounding connection member.

### BACKGROUND OF THE INVENTION

In the prior art, reliable grounding protection needs to be provided for connectors to ensure the safe operation of electrical equipment due to the increasing current carrying capacity of connectors. In the prior art, a spring is usually used to electrically connect the grounding terminal of the connector to the outer shielding shell of the connector. However, the electrical contact of the spring is unreliable, which can easily lead to poor or ineffective electrical contact, thereby causing safety hazards.

### SUMMARY OF THE INVENTION

A grounding connection member includes a cylindrical body, an elastic arm, a pair of side wings, and a pair of elastic sheets. The cylindrical body has a C-shaped cross-section, a front end, and a rear end opposite each other in an axial direction of the cylindrical body, and an opening extending between the front end and the rear end. The elastic arm is connected to the front end and electrically contacts a grounding terminal of a connector. The pair of side wings each connect to one side of the opening and spread in opposite directions. The pair of elastic sheets are each formed on one side wing and electrically contact an outer shielding shell of the connector.

### BRIEF DESCRIPTION OF DRAWINGS

The invention will now be described by way of example with reference to the accompanying figures, of which:

FIG. 1 is a perspective view of a connector according to an exemplary embodiment;

FIG. 2 is a partial exploded view of the connector of FIG. 1;

FIG. 3 is an assembly view of an inner insulation housing, a grounding terminal, a grounding connection member, and a terminal holder of the connector of FIG. 1;

FIG. 4 is an exploded view of the inner insulation housing of FIG. 3, the grounding terminal of FIG. 3, the grounding connection member of FIG. 3, and the terminal holder of FIG. 3;

FIG. 5 is an assembly view of the grounding terminal of FIG. 3, the grounding connection member of FIG. 3, and the terminal holder of FIG. 3;

FIG. 6 is a partial exploded view of the grounding terminal of FIG. 3, the grounding connection member of FIG. 3, and the terminal holder of FIG. 3;

FIG. 7 is another partial exploded view of the grounding terminal of FIG. 3, the grounding connection member of FIG. 3, and the terminal holder of FIG. 3;

FIG. 8 is an assembly view of the grounding terminal of FIG. 3 and the grounding connection member of FIG. 3;

FIG. 9 is an exploded view of the grounding terminal of FIG. 3 and the grounding connection member of FIG. 3; and

FIG. 10 is a perspective view of the grounding connection member of FIG. 3.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

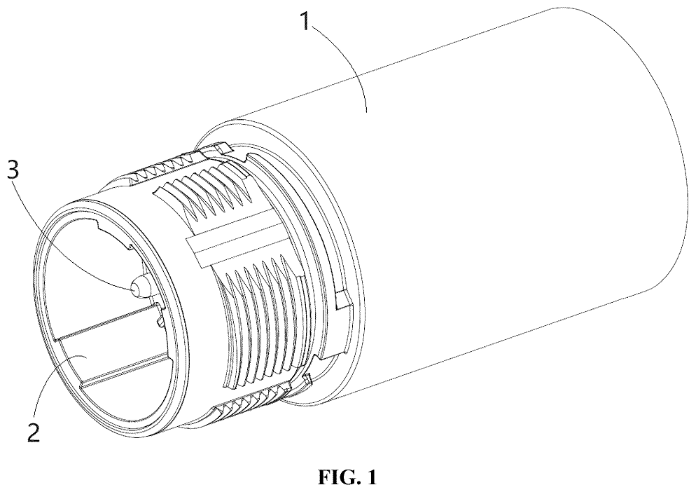

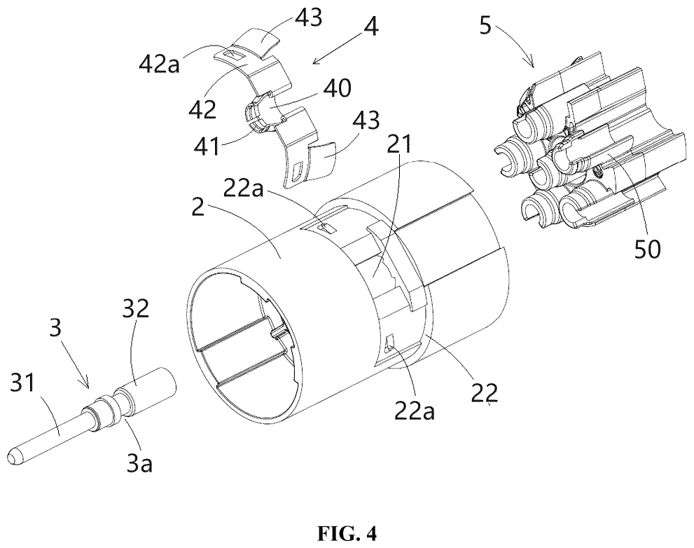

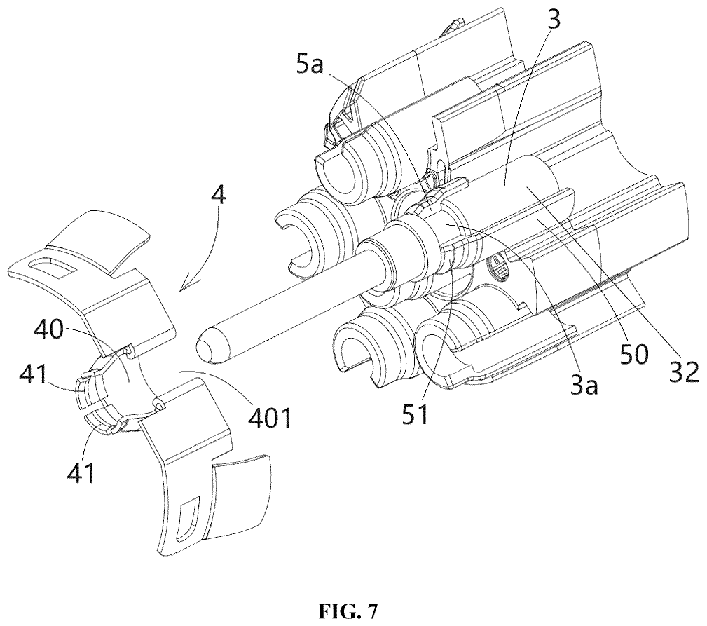

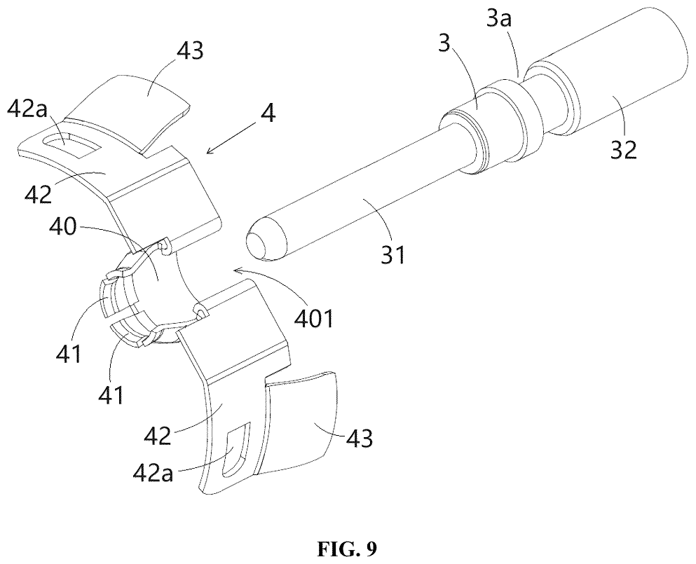

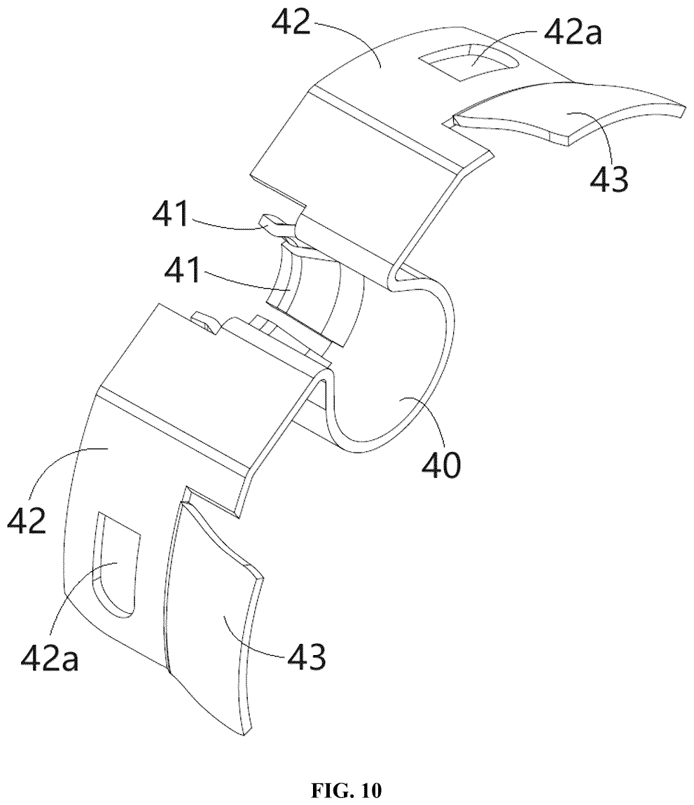

An exemplary embodiment of a grounding connection member 4 is now described with reference to FIGS. 1-10. As shown in FIG. 4, the grounding connection member 4 includes a cylindrical body 40, an elastic arm 41, a pair of side wings 42, and a pair of elastic sheets 43. As shown in FIGS. 7 and 9, the cross-section of the cylindrical body 40 is C-shaped, and the cylindrical body 40 has opposite front and rear ends in its axial direction, as well as an opening 401 extending between the front and rear ends. The elastic arm 41 is connected to the front end of the cylindrical body 40 for electrical contact with a grounding terminal 3 of a connector. The pair of side wings 42 are respectively connected to both sides of the opening 401 of the cylindrical body 40 and spread in opposite directions. The pair of elastic sheets 43 are respectively formed on the pair of side wings 42 for electrical contact with an outer shielding shell 1 of the connector.

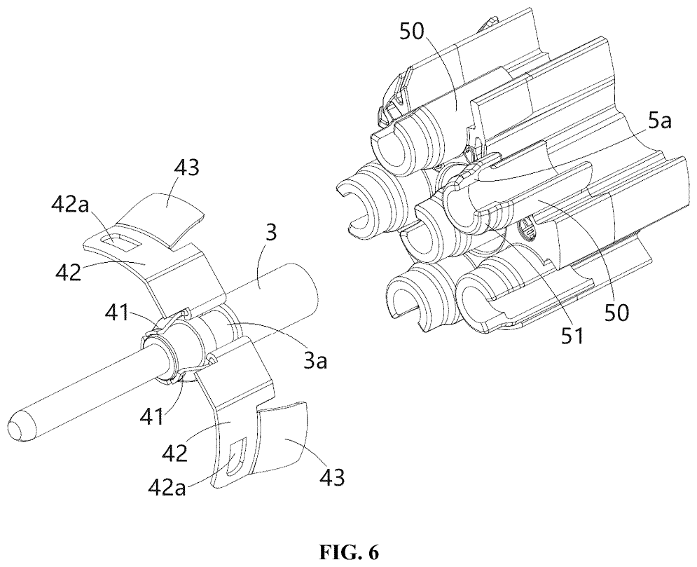

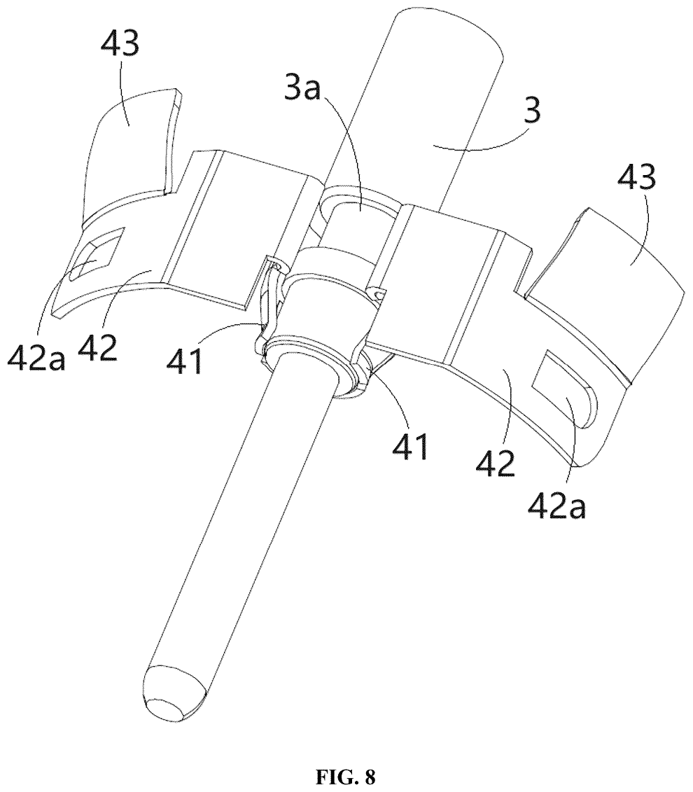

As shown in FIG. 9, the grounding connection member 4 includes multiple elastic arms 41. As shown in FIGS. 6 and 8, the multiple elastic arms 41 are distributed at intervals in the circumferential direction of the cylindrical body 40 for simultaneous electrical contact with the outer circumferential surface of the grounding terminal 3 passing through the cylindrical body 40. The cylindrical body 40 of the grounding connection member 4 is adapted to be inserted into the slot hole 21 of the inner insulation housing 2 of the connector in an interference fit manner to fix the cylindrical body 40 to the slot hole 21 of the inner insulation housing 2.

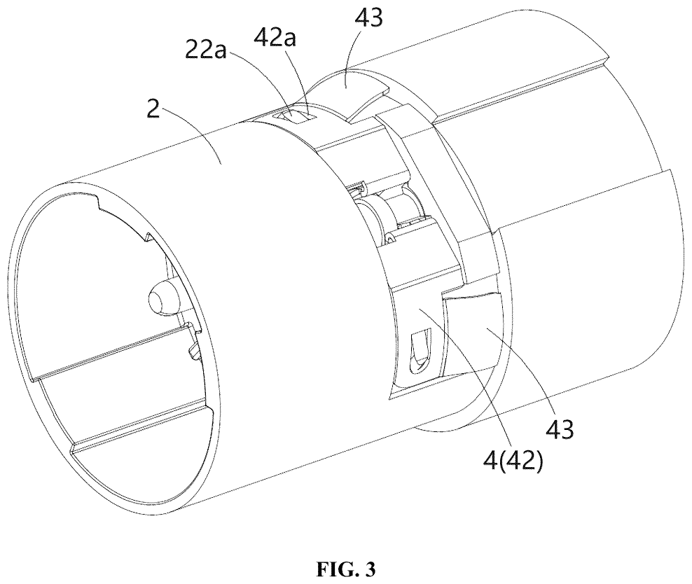

The side wings 42 of the grounding connection member 4, as shown in FIGS. 3-6 and 8-10, are adapted to be embedded in the recesses 22 on the outside of the inner insulation housing 2 to fix the side wings 42 of the grounding connection member 4 in the recesses 22 on the outside of the inner insulation housing 2.

As shown in FIGS. 3-4, 6, and 8-10, a snap slot 42a is formed in the side wing 42 of the grounding connection member 4. The snap slot 42a is suitable for engaging with a protrusion 22a in the recess 22 of the inner insulation housing 2 to fix the side wing 42 to the inner insulation housing 2.

As shown in FIGS. 3-6, and 8-10, the elastic sheet 43 extends obliquely from the rear side of the side wing 42 towards a rear direction and an outward direction. The elastic sheet 43 electrically contacts the inner peripheral surface of the outer shielding shell 1.

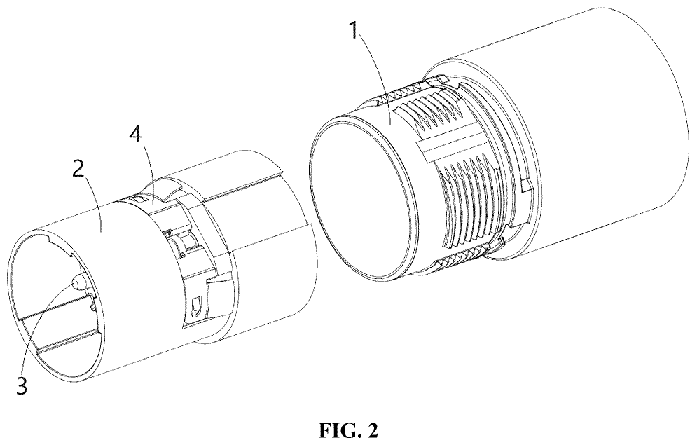

The grounding connection member 4, as shown in FIGS. 2-4, 7, and 9, is an integral stamped part. The grounding connection member 4 being an integral stamped part can reduce manufacturing costs and improve production efficiency. The grounding connection member 4 is in the shape of a bird spreading its wings or in the shape of a bird spreading its wings and flying, with the cylindrical body 40 serving as the bird's body, the elastic arm 41 serving as the bird's head, and the pair of side wings 42 serving as the bird's wings. In other words, the grounding connection member 4 has a bird with spread wings shape.

In the aforementioned exemplary embodiments according to the present invention, the grounding connection member 4 is bird shaped. The bird's head (the elastic arm 41) is in reliable electrical contact with the grounding terminal 3. The bird wings (the pair of side wings 42) are in reliable electrical contact with the outer shielding shell 1. Therefore, the grounding connection member 4 can reliably make electrical contact with the grounding terminal 3 and the outer shielding shell 1, thereby achieving a reliable and stable electrical connection between the grounding terminal 3 and the outer shielding shell 1, and improving the safety of product use. In addition, the assembly of the grounding connection member 4 of the present invention is very simple, thereby simplifying the assembly operation of the connector.

An exemplary embodiment of a connector is now described with reference to FIGS. 1-10. As shown in FIGS. 1-2, the connector includes an outer shielding shell 1, an inner insulation housing 2, the grounding connection member 4 as described above, and a grounding terminal 3. As shown in FIG. 1, the inner insulation housing 2 is installed in the outer shielding shell 1. The grounding connection member 4, as shown in FIG. 3, is inserted into the inner insulation housing 2. As shown in FIG. 2, the grounding terminal 3 is inserted into the inner insulation housing 2 and passes axially through the cylindrical body 40 of the grounding connection member 4. The elastic arm 41 of the grounding connection member 4 is in electrical contact with the outer side of the grounding terminal 3, and the elastic sheet 43 of the grounding connection member 4 is in electrical contact with the inner side of the outer shielding shell 1 to electrically connect the grounding terminal 3 to the outer shielding shell 1.

As shown in FIG. 4, a slot hole 21 is formed in the inner insulation housing 2. The slot hole 21 has an installation port located on the outer peripheral surface of the inner insulation housing 2. The cylindrical body 40 of the grounding connection member 4 is inserted into the slot hole 21 through the installation port.

As shown in FIGS. 2-3, the cylindrical body 40 of the grounding connection member 4 is interference fit with the inner wall of the slot hole 21 of the inner insulation housing 2 to fix the cylindrical body 40 into the slot hole 21 of the inner insulation housing 2.

As shown in FIG. 4, a recess 22 in communication with the slot hole 21 is formed on the outer peripheral surface of the inner insulation housing 2. As shown in FIG. 3, the side wings 42 of the grounding connection member 4 are embedded in the recess 22 of the inner insulation housing 2. The elastic sheet 43 of the grounding connection member 4, as shown in FIG. 3, protrudes from the recess 22 for electrical contact with the inner side of the outer shielding shell 1.

As shown in FIGS. 3-4, a protrusion 22a is formed in the recess 22 of the inner insulation housing 2. As shown in FIG. 3, the protrusion 22a is engaged with the snap slot 42a on the side wing 42 of the grounding connection member 4 to fix the side wing 42 of the grounding connection member 4 in the recess 22 of the inner insulation housing 2.

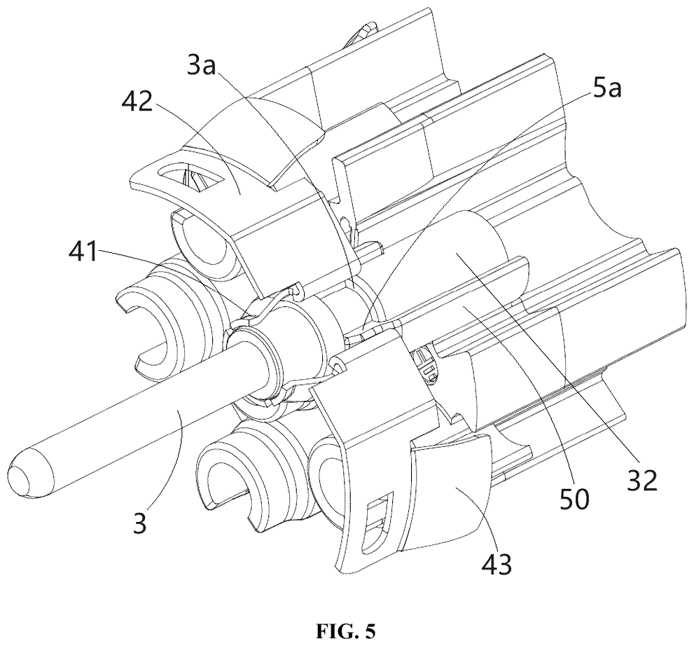

As shown in FIG. 4, the connector further comprises a terminal holder 5 formed with a terminal holding cylinder 50. The terminal holder 5 is inserted into the inner insulation housing 2. As shown in FIGS. 5 and 7, the rear end 32 of the grounding terminal 3 is held in the terminal holding cylinder 50.

As shown in FIGS. 4-7, the cross-section of the terminal holding cylinder 50 is C-shaped and has an opening extending along its axial direction, allowing the terminal holding cylinder 50 to undergo elastic deformation in its radial direction. The rear end 32 of the grounding terminal 3 is in interference fit with the inner peripheral surface of the terminal holding cylinder 50 to hold the grounding terminal 3 in the terminal holding cylinder 50.

As shown in FIGS. 6-7, an annular protrusion 5a is formed on the inner side of the front end 51 of the terminal holding cylinder 50. An annular groove 3a, as shown in FIGS. 4-9, is formed on the grounding terminal 3. The annular protrusion 5a is engaged into the annular groove 3a to fix the grounding terminal 3 to the terminal holder 5.

As shown in FIGS. 6 and 8, the annular groove 3a on the grounding terminal 3 is received in the cylindrical body 40 of the grounding connection member 4. The front end 51 of the terminal holding cylinder 50 is inserted into the cylindrical body 40 of the grounding connection member 4 and engaged into the annular groove 3a. The cylindrical body 40 of the grounding connection member 4 is clamped and fixed between the inner peripheral surface of the slot hole 21 of the inner insulation housing 2 and the outer peripheral surface of the front end 51 of the terminal holding cylinder 50.

The connector also includes a signal terminal. The signal terminal is inserted into the inner insulation housing 2. The terminal holder 5 has multiple terminal holding cylinders 50, and the rear ends of the grounding terminal 3 and the signal terminal are respectively held in the multiple terminal holding cylinders 50.

The rear end 32 of the grounding terminal 3 is suitable for electrical connection with a grounding cable, and the front end 31 of the grounding terminal 3 extends from the cylindrical body 40 of the grounding connection member 4 for mating with a mating grounding terminal of a mating connector. The rear end of the signal terminal is suitable for electrical connection with a signal cable, and the front end of the signal terminal extends from the terminal holding cylinder 50 for mating with a mating signal terminal of the mating connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1 A grounding connection member, comprising:
a cylindrical body with a C-shaped cross-section, the cylindrical body has a front end and a rear end opposite each other in an axial direction of the cylindrical body and an opening extending between the front end and the rear end;
an elastic arm connected to the front end and electrically contacting a grounding terminal of a connector;
a pair of side wings each connected to one side of the opening and spread in opposite directions; and
a pair of elastic sheets each formed on one side wing and electrically contacting an outer shielding shell of the connector.

2. The grounding connection member of claim 1, wherein the grounding connection member has a plurality of elastic arms each distributed at intervals in a circumferential direction of the cylindrical body, each elastic arm simultaneously electrically contacts an outer circumferential surface of the grounding terminal passing through the cylindrical body.

3. The grounding connection member of claim 1, wherein the cylindrical body of the grounding connection member is inserted into and interference fit with a slot hole of an inner insulation housing of the connector to fix the cylindrical body to the slot hole.

4. The grounding connection member of claim 3, wherein the side wings are each embedded and fixed in one recess on an outside of the inner insulation housing.

5. The grounding connection member of claim 4, wherein a snap slot is formed on one side wing, the snap slot engages with a protrusion in one recess to fix the one side wing to the inner insulation housing.

6. The grounding connection member of claim 1, wherein each elastic sheet extends obliquely from a rear side of one side wing towards a rear direction and an outward direction, each elastic sheet electrically contacts an inner peripheral surface of the outer shielding shell.

7. The grounding connection member of claim 1, wherein the grounding connection member is an integral stamped part.

8. The grounding connection member of claim 1, wherein the grounding connection member has a bird with spread wings shape, the cylindrical body serves as a bird body, the elastic arm serves as a bird head, and the pair of side wings serve as a pair of bird wings.

9. A connector, comprising:
an outer shielding shell;
an inner insulation housing installed in the outer shielding shell;
a grounding connection member including a cylindrical body, an elastic arm, a pair of side wings, and a pair of elastic sheets, the cylindrical body has a C-shaped cross-section, a front end and a rear end opposite each other in an axial direction of the cylindrical body, and an opening extending between the front end of the cylindrical body and the rear end of the cylindrical body, the elastic arm is connected to the front end of the cylindrical body, the pair of side wings are each connected to one side of the opening of the cylindrical body and spread in opposite directions, and the pair of elastic sheets are each formed on one side wing and electrically contact the outer shielding shell, the grounding connection member is inserted into the inner insulation housing; and
a grounding terminal inserted into the inner insulation housing and passing axially through the cylindrical body, the elastic arm is in electrical contact with the outer side of the grounding terminal, and an elastic piece of the grounding connection member is in electrical contact with the inner side of the outer shielding shell to electrically connect the grounding terminal to the outer shielding shell.

10. The connector according to claim 9, wherein a slot hole is formed in the inner insulation housing, the slot hole has an installation port on an outer peripheral surface of the inner insulation housing, the cylindrical body is inserted into the slot hole through the installation port.

11. The connector of claim 10, wherein the cylindrical body is interference fit with an inner wall of the slot hole to fix the cylindrical body into the slot hole.

12. The connector of claim 10, wherein a recess in communication with the slot hole is formed on the outer peripheral surface of the inner insulation housing, one side wing is embedded in the recess, the elastic piece protrudes from the recess and electrically contacts an inner side of the outer shielding shell.

13. The connector of claim 12, wherein a protrusion is formed in the recess of the inner insulation housing, the protrusion is engaged with a snap slot in the one side wing to fix the one side wing in the recess.

14. The connector of claim 9, further comprising a terminal holder inserted into the inner insulation housing and formed with a terminal holding cylinder, the rear end of the grounding terminal is held in the terminal holding cylinder.

15. The connector of claim 14, wherein a cross-section of the terminal holding cylinder is C-shaped and has an opening extending along an axial direction of the terminal holding cylinder, the terminal holding cylinder undergoes elastic deformation in a radial direction of the terminal holding cylinder, the rear end of the grounding terminal is interference fit with an inner peripheral surface of the terminal holding cylinder to hold the grounding terminal in the terminal holding cylinder.

16. The connector of claim 15, wherein an annular protrusion is formed on an inner side of a front end of the terminal holding cylinder, and an annular groove is formed on the grounding terminal, the annular protrusion engages into the annular groove to fix the grounding terminal to the terminal holder.

17. The connector of claim 16, wherein the annular groove is received in the cylindrical body, and the front end of the terminal holding cylinder is inserted into the cylindrical body and engaged into the annular groove.

18. The connector of claim 17, wherein the cylindrical body is clamped and fixed between an inner peripheral surface of a slot hole formed in the inner insulation housing and an outer peripheral surface of the front end of the terminal holding cylinder.

19. The connector of claim 14, further comprising a signal terminal inserted into the inner insulation housing, the terminal holder has a plurality of terminal holding cylinders, the rear end of the grounding terminal and a rear end of the signal terminal are each held in one holding cylinders.

20. The connector of claim 19, wherein the rear end of the grounding terminal electrically connects with a grounding cable, a front end of the grounding terminal extends from the cylindrical body and mates with a mating grounding terminal of a mating connector, the rear end of the signal terminal electrically connects with a signal cable, and a front end of the signal terminal extends from the terminal holding cylinder and mates with a mating signal terminal of the mating connector.
